(19) United States
(12) Patent Application Publication
(10) Pub. No.: US 2008/0246975 A1
(43) Pub. Date: Oct. 9, 2008

(54) Handwritten annotation recognition for copy jobs

(75) Inventors: John B. Poxon, Stevenage (GB); Scott Potter, Welwyn Garden City (GB); Pieter Mulder, Welwyn Garden City (GB); Kirsty Greeen, Letchworth Garden City (GB)

Correspondence Address: FAY SHARPE / XEROX - ROCHESTER, 1100 SUPERIOR AVE., SUITE 700, CLEVELAND, OH, 44114, US

(73) Assignee: XEROX CORPORATION

(21) Appl. No.: 11/784,393

(22) Filed: Apr. 6, 2007

(51) Int. Cl. G06F 3/12

(52) U.S. Cl. 358/1.1; 358/1.15

(57) ABSTRACT

A method for annotating pages of a copy job includes scanning pages of a hardcopy document to generate digital image data for a copy job. A template is provided for a user to annotate in a selected region or regions. The template with an annotation applied by a user is scanned. An annotation image is derived from the scanned template and can be incorporated into the pages of the copy job. When printed as a hardcopy, each page of the copy job may thus include an image of the user's handwritten annotations.

### BACKGROUND

The exemplary embodiment relates to the reproduction arts. It finds particular application in combination with a template which enables handwritten annotations to be incorporated into a copy job and will be described with particular reference thereto.

Reproduction devices, such as copiers and multi-function devices with copying, printing and faxing capabilities, are widely used for making multiple copies of an original hardcopy document. Each copy is nominally identical to the other copies and the original. In some cases, a user way wish to distribute copies which have additional information specific to a particular use. For example, a user may wish to make a set of copies with identifying information such as “confidential” or “meeting handouts for August 9 meeting” or “draft” printed on the copies but does not wish to modify the original document. Or, the user may wish to provide instructions for recipients, such as “do not circulate,” “destroy after meeting,” or the like. While the user may make a copy of the original document, annotate it by hand, then copy it, this can be time consuming, particularly when the user wants to add the same information to multiple pages of a document.

Some reproduction devices allow a user to type an annotation to be added to a copy using a graphical user interface. While such techniques are useful in creating documents of high quality which are to be archived, the process of inputting an annotation using the limited typing capabilities of a copier's GUI may be daunting when the copy job is simply for circulation at an upcoming meeting and may deter users from employing the function.

### INCORPORATION BY REFERENCE

The following references, the disclosures of which are incorporated in their entireties by reference, are mentioned:

U.S. Pat. No. 6,950,982, entitled ACTIVE ANNOTATION MECHANISM FOR DOCUMENT MANAGEMENT SYSTEMS, by Dourish, discloses an annotation mechanism which detects annotations on a document and determines whether the annotation of the document requires further action or whether the annotation is simply commentaries on the text, a note of other related items, or the like. Application Serial No. 20040139391, published Jul. 15, 2004, entitled INTEGRATION OF HANDWRITTEN ANNOTATIONS INTO AN ELECTRONIC ORIGINAL, by Stumbo, et al. discloses a method in which manual changes made to a hard copy of an electronic original are determined by comparing a scanned electronic copy of the marked-up document and the electronic original and subtracting the original from the marked-up copy creating a difference copy. The differences are assumed to be annotations, grouped, and inserted into the original document as markers.

### BRIEF DESCRIPTION

In accordance with one aspect of the exemplary embodiment, a method for annotating pages of a copy job includes scanning pages of a hardcopy document to generate digital image data for a copy job, scanning a template comprising an annotation applied by a user, deriving an annotation image from the scanned template, incorporating the annotation image into at least one page of the copy job, and printing at least one hardcopy of the copy job.

In accordance with another aspect of the exemplary embodiment, an image processing apparatus includes an annotation processing unit which, in an annotation mode, is configured for receiving digital image data derived by scanning pages of a hardcopy document and digital image data derived by scanning a template comprising an annotation applied by a user, deriving an annotation image from the image data derived by scanning the template and incorporating the annotation image into each of a plurality of pages of a copy job derived from the digital image data. A printer which receives the copy job and prints at least one hardcopy of the copy job.

In accordance with another aspect of the exemplary embodiment, a method for annotating pages of a copy job includes, in response to an invocation of an annotation mode of an image processing apparatus, printing a template for a user to annotate, the template including at least one region designated for applying a handwritten annotation, each of the at least one regions being associated with a location on a page of a copy job. The method further includes scanning pages of a hardcopy document to generate digital image data for a copy job, scanning the user-annotated template, deriving an annotation image from the scanned template, incorporating the annotation image from the at least one region of the scanned template into a plurality of pages of the copy job at the associated location, and printing at least one hardcopy of the copy job.

### BRIEF DESCRIPTION OF THE DRAWINGS

FIG. 1 illustrates a template for receiving user annotations for a copy job in accordance with one aspect of the exemplary embodiment;

FIG. 2 is a functional block diagram of an image processing apparatus which incorporates an annotation processing unit in accordance with another aspect of the exemplary embodiment; and

FIG. 3 is a flow chart which illustrates steps in an exemplary method of annotating pages of a document copy in accordance with another aspect of the exemplary embodiment.

### DETAILED DESCRIPTION

Aspects of the exemplary embodiment relate to a system and method for processing a copy job to incorporate a user's handwritten annotations. In the exemplary embodiment, the annotations are handwritten on a template which is scanned with the hardcopy document to be copied.

A copy job or “document” is normally a set of related sheets, usually one or more collated copy sets copied from a set of original sheets from a particular user, or otherwise related. An image generally may include information in electronic form which is to be rendered on the print media by a printer and may include text, graphics, pictures, and the like.

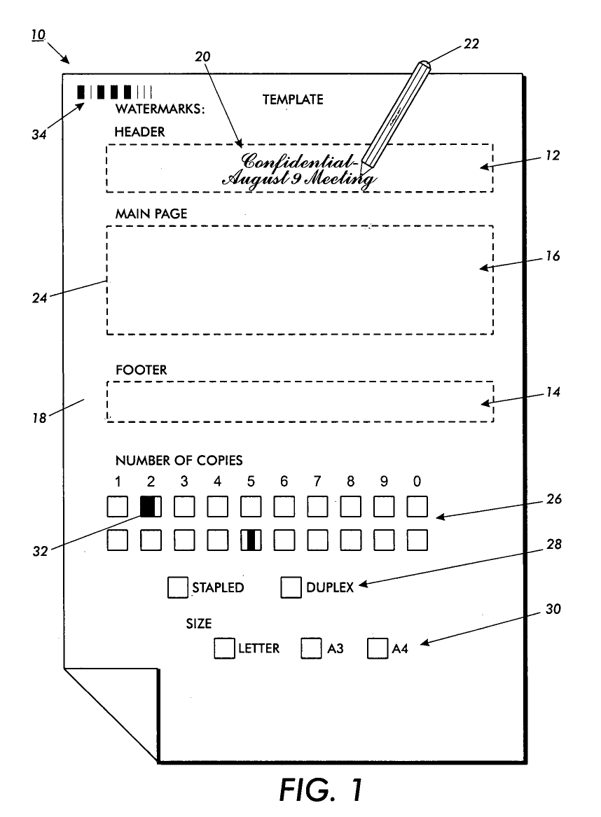

FIG. 1 illustrates an exemplary template 10 in accordance with the present embodiment. The template 10 allows a user to provide handwritten annotations to be incorporated into a copy job, such as a set of pages to be copied from a hardcopy original document. The template 10 includes one or more predefined regions 12, 14, 16, designated as annotation regions. Each region comprises less than an entire area of the template. Each of the regions 12, 14, 16 has a predetermined shape, size, and location.

While the illustrated regions 12, 14, 16 are rectangular, other shapes, such as squares, triangles, circles, or the like are also contemplated. When the template 10 is printed on a print media substrate 18, such as paper, a user may annotate one or more of the regions 12, 14, 16 by applying a handwritten image 20, such as words or a drawing, by using a pen, pencil or other suitable annotation device 22. The applied annotations 20 are subsequently incorporated into a copy job, as described in greater detail below.

The regions 12, 14, 16, may each be associated with a particular portion of a page of the copy job. In the illustrated embodiment, one of the regions 12 is designated as a header region. Annotations 20 to this region may be incorporated as an image in a header area of each page of the copy job. Another region 14 is designated as a footer region. Annotations made here are to be printed as a footer on each page of the copy job. The header and footer regions of the copy job may be outside the normal printed area of the page, where there is typically no content on the copy job. As will be appreciated, it is also contemplated that annotations may be designated for other locations in the white space of a page, such as down the sides of the page. A third region 16 is designated as a main page region. Annotations in this region may be printed within the printed region of each page of the copy job. To allow the content of the copy job to be readily visible, the annotations in region 16 may printed as a light gray on the copy job. The approximate locations of each of the regions 12, 14, 16 on the template 10 may be used to encode the corresponding location on the copy job where the annotation is to be inserted.

Each of the regions 12, 14, 16 may include a boundary 23, here illustrated by dashed lines, which delimits the annotatable area of the respective region.

Optionally, the template 10 may include job ticket specification regions, such as a plurality of user selectable check boxes 26, 28, 30, etc., whereby a user may select one or more copy functions, such as the number of copies of the copy job to be printed, finishing operations, such as stapling, duplex (two sided) copying, and paper size. The user may fill in one or more of the check boxes for selecting these features. For example, in the illustrated embodiment, the user has applied handwritten annotations 32, i.e., checked boxes 2 (tens) and 5 (units) in the first and second rows. This indicates that 25 copies should be made. The resulting copy job will be printed using the default specifications for paper size and single sided copying without stapling, since these features have not been checked.

The template may further include machine readable indicia which uniquely identifies the page as a template, here illustrated as a barcode 34.

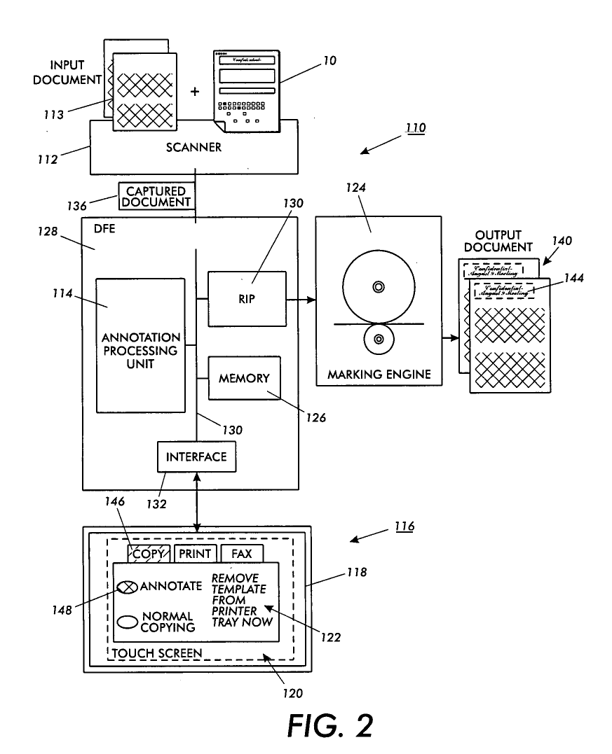

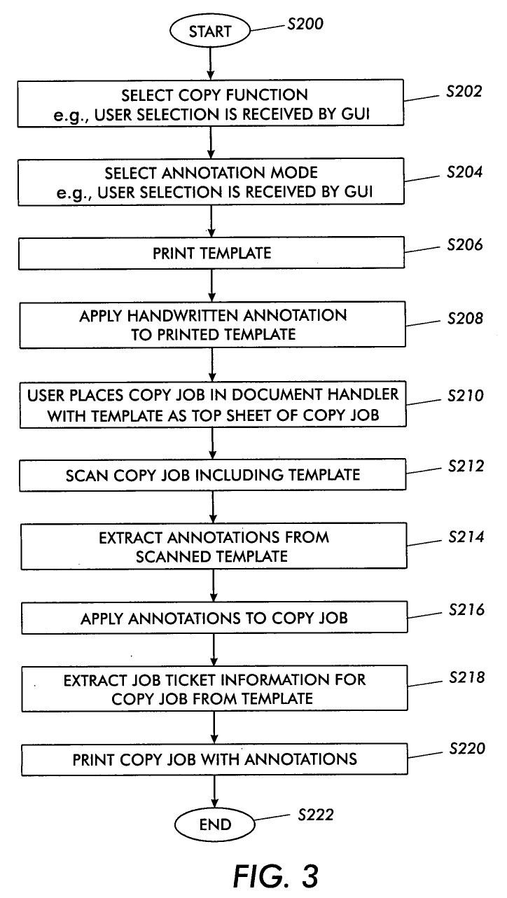

FIG. 2 illustrates a digital image processing apparatus or reproduction apparatus 110, formed in accordance with the present embodiment. The image processing apparatus 110 can be embodied in a scanning/copying system, e.g., a digital copier or a multifunction (scan/print/fax/copy) digital image processing system or the like. More particularly, the image processing apparatus 110 includes a scanner 112 for receiving a copy job 113 which may include one or more printed document pages and an annotated template 10 as input and deriving digital data that represent the printed document page as output. The system 110 further includes an annotation processing unit (APU) 114 for performing digital image processing operations in accordance with the exemplary method described with reference to FIG. 3. In particular, the APU 114 executes instructions for receiving input digital image data and processing the data to provide an annotated copy job to be output in accordance with stored algorithms and/or based on user-selected functions. The system 110 further comprises one (or more) user input device 116 that is operatively connected to the APU 114 and that allows a user to input data to the annotation processing unit 114 to control the annotation processing operations and all other functions of the system 110. The illustrated user input device 116 is in the form of a graphical user interface (GUI). The GUI includes a visual display 118 and a touch screen 120 for inputting information and command selections to the APU 114 by using a finger or a stylus or the like to select an object displayed on the video screen of the visual display 118. However, other user input devices are also contemplated, such as a cursor control device, e.g., a mouse, a keypad, alphanumeric keyboard, stylus, or combination thereof.

In the illustrated embodiment, the GUI 116 is configured for allowing a user to select a copying function and within the copying function, to select an annotation mode or to select other copying modes which do not include annotation. The GUI is also configured for displaying instructions 122 to the user when the annotation mode is selected.

The system 110 further comprises one or more output devices that are operatively connected to the APU 114, herein illustrated as a printer 124. The system 110 further includes memory 126 accessible by the APU, which may store a soft copy of a template, such as exemplary template 10, in digital form. Memory 126 may also store print jobs during processing by the APU and/or instructions executed by the APU.

The APU 114 may comprise a single processing unit, or be distributed across one or more processing units in one or more locations, e.g., on a client and server. In the illustrated embodiment, the APU 14 is resident in the printer's computer, generally referred to as a Digital Front End (DFE) 128. The APU may be in the form of software, hardware, or both. In one embodiment, the APU is in the form of an add-on software component. As will be appreciated the DFE 128 may include a variety of other processing units, such as a raster image processor (RIP) 130 for converting a copy job into a format which can be processed by the printer and an interface unit for communicatively linking the GUI 116 with the APU. The various processing components of the DFE may be operatively connected by a data/control bus 134.

Memory 126 may comprise any known type of data storage and/or transmission media, including magnetic media, optical media, random access memory (RAM), read-only memory (ROM), a data cache, a data object, etc. Moreover, memory 126 may reside at a single physical location, comprising one or more types of data storage, or be distributed across a plurality of physical systems in various forms.

In the exemplary embodiment, the scanner 112 may include a platen and/or document feeder, on which documents to be scanned are positioned, and a source of illumination, such as a row of light emitting diodes or the like, which illuminates the document. Reflected light is collected by a lens arrangement and recorded by a photosensitive device, which may include one or more linear arrays of photosensors. The scanner 112 includes a suitable processing device which generates, for each page of the document, an image comprising signals representative of reflected light recorded by the photosensitive device.

The scanner 112 can be replaced by another device such as storage device, camera or the like that supplies input image data to the annotation processing unit 114.

The printer 124 can include any device for rendering an image on print media. In rendering a copy job, the printer applies colorants, such as inks or toners, to the print media. The printer 124 may employ xerographic printing technology, inkjet printing technology, or the like. The print media can be a physical sheet of paper, plastic, or other suitable physical print media substrate for images.

In the most general terms, pages of a document 113 having one or more printed pages together with a user annotated copy of template 10 are processed by the scanner 112 to derive digital image data 136 that represent the printed pages and the template 10. The digital image data are input from the scanner 112 to the APU 114 and are output from the APU, in original or processed form based upon stored image processing algorithms, image processing circuitry, and/or user input from the input device 116, to the printer 124 for generation of a new printed document and/or to memory 126 for saving the data. In particular, the APU 114 executes instructions for performing computer implemented steps of the method described in greater detail with reference to FIG. 3 such that the printer outputs a hardcopy document 140 in which a plurality of the document pages include an annotation image 144 derived from the captured annotated region or regions 12, 14, 16 of the template 10.

FIG. 3 is a diagrammatic illustration of a method for incorporating user annotations into a copy job in accordance with the exemplary embodiment that can be implemented using the system of FIG. 2. The method may include fewer, more, or different steps to those illustrated and need not proceed exactly in the order illustrated. The method begins at S200.

At S202, a user wishing to make an annotated copy of a hard copy document comprising one or more pages walks up to the copying system 110. Options, such as copying, printing, faxing, etc may be presented to the user, e.g., via the GUI 116. The user may select the copy function of the image processing apparatus 110. For example, in the illustrated embodiment, the user selects the “copy” tab 146 by pressing the GUI screen 120.

At S204, in response to selection of the copying function, various selectable copy features may be presented to the user, e.g., displayed on the GUI, including a feature representing an annotation mode. The user may select the annotation mode, by pressing on the associated button 148, or may proceed as for a normal copy job without annotation. The GUI 116 registers the user's selection of the annotation feature and notifies the APU 114. In other embodiments, where the template includes machine readable indicia which identifies it as a template, this step may be omitted and the annotation mode invoked automatically by identifying the indicia.

At S206, in response to the user's selection of the annotation mode, the APU 114 causes a copy of the template 10 to be printed by printer 124. In particular, the APU may retrieve the digital copy of template 10 from memory 126 and send it as a single page print job to printer 126 for printing in hardcopy form on print media. The GUI may display instructions 122 at this time, indicating that the user should remove the printed template 10 from the printer's output tray and add the user's selected handwritten annotations. In other embodiments, hardcopies of the template 10 may be pre-printed, in which case, the printing of the template at S206 may be omitted.

At S208, the user identifies annotations to be incorporated into the copy job by applying one or more annotations to one or more regions 12, 14, 16 of the printed template 10. Each annotation may include one or more handwritten annotation marks, such as letters, numbers, or other characters, or a drawing within a selected region or regions 12, 14, 16. By way of example, the user may write the words “confidential—August 9 Meeting” in the region 12, as illustrated in FIG. 1.

At S210, the user places the copy job 113 and annotated template 10 on the document feeder of the scanner and at S212, the copy job, including the document pages 113 and annotated template 10, is scanned by the scanner. The template 10 may be placed as the first page of the copy job in the scanner's document handler or in another suitable location by which it can be readily distinguished from the rest of the pages of the copy job as a template. Alternatively or additionally, machine readable indicia 34 on the template 10 render the template image distinguishable by the APU 114. Digital image data representative of the scanned document pages and template are sent to the APU.

At S214, in the annotation mode, one or more digital annotation images 144 are automatically extracted from the image of the template 10. In particular, the APU 114 identifies the template page, for example, by identifying the indicia 34 or because it is first in a copy job designated to be processed in the annotation mode. The APU 114 then captures the region(s) 12, 14, 16 designated for annotation. For example, the APU identifies borders 24 of the regions 12, 14, 16 by searching for dashed lines and identifying the pixel locations of the region's border. As will be readily appreciated, since each of the regions 12, 14, 16 comprises less than the entire image area of the template, the captured image comprises less than the entire image data for the scanned page, i.e., in capturing the image, part of the image data of the page is excluded. Other methods are available for identifying hand-drawn annotations, as described, for example, in application Ser. No. 10/342641 to Stumbo, et al., incorporated herein by reference. Filtering may be applied to determine whether, for each region 12, 14, 16, the region includes any annotation marks and to ignore the region if it does not. Each of the regions 12, 14, 16, defined within its respective border 24, may be treated as a separate annotation image. This image, comprising the digital data making up the region, may thus be captured and stored in memory 126. There is thus no need for optical character recognition (OCR) to convert the image to text, although it is contemplated that OCR techniques may optionally be employed.

At S216, the captured images 144 of the regions are applied to the copy job. For example, pixels of the images of the copy job pages are modified in specific areas designated for receiving an annotation image 144 from the selected annotation region 12, 14, 16. In the case of an annotation 20 placed in header region 12, for example, the pixels of a designated header area of each image page of the copy job are modified to incorporate the annotation image captured from region 12. In other embodiments, the captured annotation image 144 may be linked as an object to a specific location in each page of the document, for example using a suitable markup language, such as hypertext markup language (HTML). Certain modifications may be made to the annotation image 144 prior to locating it in the document. For example, the size of the image, color of the image, orientation, or the like may be changed. In the case of annotations placed in region 16, for example, the gray level values of pixels in the image may be reduced, the image enlarged to the size of the printed region of the page, and the orientation changed so that the image is angled to other text in the central area of the document page. Herein, reducing gray level values refers to decreasing intensity for any channel, irrespective of whether it is a monochrome or a color channel. In the case of a color image, a user may be given the opportunity to select a particular color channel (e.g., C, M, Y, or K) for the annotations to be placed in region 16 to allow them to be distinguished from the image content, e.g., via a check box on the template (not shown).

At S218 other information from the template may be extracted which is encoded by one or more of the checked boxes 26, 28, 30. This may include extracting job ticket information from the image of the template, such as number of copies, duplex printing, stapling or the like.

At S220, the copy job is placed in a suitable format for printing by the raster image processor and one or more copies are printed by the printer in accordance with the job ticket information. The printed document includes a plurality of pages, each with an annotation image 144, as well as other images derived from the captured document 113. As will be appreciated, the copy job, as printed, does not include a page for the annotated template—the annotated template page is not printed. The method ends at S222.

While in the illustrated embodiment, all pages of the document include an identical annotation image, it is also contemplated that fewer than all pages may include an annotation image, for example, by indicating, on the template, pages to which the annotation is to be applied. Additionally or alternatively, different annotation images may be applied to different pages of the copy job in a similar manner.

The computer implemented steps of the method illustrated in FIG. 3 (e.g., all steps other than S208 and S210) may be implemented in a computer program product that may be executed on a computer. The computer program product may be a tangible computer-readable recording medium on which a control program is recorded, such as a disk, hard drive, or may be a transmittable carrier wave in which the control program is embodied as a data signal. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, transmission media, such as acoustic or light waves, such as those generated during radio wave and infrared data communications, and the like, or any other medium from which a computer can read and use.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, or PAL, or the like. In general, any device, capable of implementing a finite state machine that is in turn capable of implementing the computer implemented steps of the flowchart shown in FIG. 3, can be used to implement the method for annotating a document.

It will be appreciated that the exemplary method may include fewer, more or different steps and that the steps need not proceed in the order illustrated. It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. a method for annotating pages of a copy job comprising:
scanning pages of a hardcopy document to generate digital image data for a copy job;
scanning a template comprising an annotation applied by a user;
deriving an annotation image from the scanned template;
incorporating the annotation image into at least one page of the copy job; and
printing at least one hardcopy of the copy job.

2. The method of claim 1, further comprising:
printing the template prior to the scanning of the template.

3. The method of claim 1, wherein the incorporating the annotation image into at least one page includes incorporating the annotation image into each of a plurality of pages of the copy job.

4. The method of claim 1, further comprising:
printing the template in response to a user selection of an annotation mode.

5. The method of claim 1, further comprising invoking an annotation mode of an image processing apparatus, and wherein in the annotation mode, the deriving of the annotation image and the incorporation of the annotation image are performed automatically.

6. The method of claim 5, wherein the annotation mode is invoked by a user selection on a user interface.

7. The method of claim 1, wherein the template includes at least one predefined region which is designated for receiving a user applied annotation and wherein the deriving of the annotation image includes capturing an image of the region.

8. The method of claim 1, wherein the template is scanned with the pages of the hardcopy document.

9. The method of claim 8, further comprising identifying the scanned template for deriving the annotation image therefrom.

10. The method of claim 1, wherein the template includes machine readable indicia for distinguishing the scanned template from the scanned pages of the document.

11. The method of claim 1, further comprising:
printing the template in response to the annotation mode being invoked.

12. The method of claim 1, wherein a location of the annotation image in the template encodes a location for the annotation image in each of the plurality of pages of the copy job and wherein the incorporating the annotation image into each of the plurality of pages of the copy job includes locating the annotation image in the location encoded by the template.

13. The method of claim 12, wherein when the location of the annotation image encodes a central location of the copy job, the deriving an annotation image from the scanned template includes modifying a gray level of the annotation image.

14. The method of claim 1, wherein the template includes at least one annotation region and wherein the deriving of the annotation image from the scanned template includes extracting the annotation image from a corresponding region of the scanned template.

15. The method of claim 14, wherein the template includes a plurality of annotation regions, each of the plurality of regions being associated with a different location in the copy job pages and wherein when the annotation image is extracted from a first of the regions, the incorporating of the annotation image into each of a plurality of pages of the copy job includes incorporating the annotation image into a first of the locations and wherein when the annotation image is extracted from a second of the regions, the incorporating of the annotation image into each of a plurality of pages of the copy job includes incorporating the annotation image into a second of the locations.

16. The method of claim 1, further comprising extracting job ticket information from the scanned template and wherein the printing at least one hardcopy of the copy job includes printing the at least one hardcopy in accordance with the extracted job ticket information.

17. The method of claim 1, wherein the applied annotations are handwritten by the user.

18. A computer program product encoding instructions, which when executed on a computer causes the computer to perform the method of claim 1.

19. An image processing apparatus comprising memory which stores instructions for performing the method of claim 1 and a processing unit for executing the instructions.

20. An image processing apparatus comprising:
an annotation processing unit which, in an annotation mode, is configured for receiving digital image data derived by scanning pages of a hardcopy document and digital image data derived by scanning a template comprising an annotation applied by a user, deriving an annotation image from the image data derived by scanning the template and incorporating the annotation image into each of a plurality of pages of a copy job derived from the digital image data; and
a printer which receives the copy job and prints at least one hardcopy of the copy job.

21. The image processing apparatus of claim 20, further comprising a user input device which enables a user to invoke the annotation mode.

22. The image processing apparatus of claim 20, wherein, in the annotation mode, the annotation processing unit causes the template to be printed by the printer.

23. The image processing apparatus of claim 20, further comprising memory which stores a digital copy of the template for printing by the printer.

24. The image processing apparatus of claim 21, wherein the annotation processing unit is configured for extracting job ticket information form the template and wherein the printer prints the copy job in accordance with the extracted job ticket information.

25. A template for use with the apparatus of claim 20.

26. A method for annotating pages of a copy job comprising:
in response to an invocation of an annotation mode of an image processing apparatus, printing a template for a user to annotate, the template including at least one region designated for applying a handwritten annotation, each of the at least one region being associated with a location on a page of a copy job;
scanning pages of a hardcopy document to generate digital image data for a copy job;
scanning the user-annotated template;
deriving an annotation image from the at least one region of the scanned template;
incorporating the annotation image into a plurality of pages of the copy job at the associated location; and
printing at least one hardcopy of the copy job.
